(19) United States
(12) Patent Application Publication
(10) Pub. No.: US 2017/0240406 A1
(43) Pub. Date: Aug. 24, 2017

(54) DETACHABLE DISPENSING SYSTEM FOR BOTTLED LIQUID

(71) Applicants: Jasmina PEROVIC, Beograd (RS); Bojan LAZIC, Beograd (RS); Milos MILOSEVIC, Beograd (RS); Uros TATIC, Beograd (RS); Simon SEDMAK, Beograd (RS)

(72) Inventors: Jasmina PEROVIC, Beograd (RS); Bojan LAZIC, Beograd (RS); Milos MILOSEVIC, Beograd (RS); Uros TATIC, Beograd (RS); Simon SEDMAK, Beograd (RS)

(21) Appl. No.: 15/500,059

(22) PCT Filed: Jul. 24, 2015
(86) PCT No.: PCT/RS2015/000019

§ 371 Date: Jan. 29, 2017

(30) Foreign Application Priority Data
Jul. 30, 2014 (RS) P-2014/0400

(51) Int. Cl. B67D 1/04; B67D 1/08; B67D 1/00

(52) U.S. Cl. CPC B67D 1/0412; B67D 1/0006; B67D 1/0085; B67D 1/0885

(57) ABSTRACT

A system for dispensing a liquid from a bottle 13 comprises an assembly 17, 18 and a stopper 19 to be introduced into a bottleneck, which stopper can be separated from the assembly. The stopper 19 comprises a liquid dispensing pipe 14, 16 with a electromagnetic valve 15 and a gas path 12 having a check valve 11 therein. The assembly comprises a solenoid 10 and a tank 1 containing gas for driving the liquid from the bottle. The tank is connected via a further electromagnetic valve 3 to gas pipes 8 and 9. The stopper which closes off the bottle can be connected to the assembly such that gas pipe 9 connects with check valve 12 and solenoid 10 surrounds electromagnetic valve 15. By actuating programmable button switch 4 both electromagnetic valves 3, 15 open for a preset time so that a metered quantity of liquid is dispensed from the bottle. Alternatively, another button switch 5 allows to dispense a non-preset volume of liquid.

### TECHNICAL FIELD OF THE INVENTION

This invention belongs to the field of storage and transport in general, and relates to a detachable precious liquids dispenser system.

According to the International Patent Classification (IPC), this invention can be denoted using the classification symbol B65D83/00, which is used for denoting packaging with special means for dispensing their contents, or by using the slightly more relevant symbol, B65D83/14, which is used for devices which dispense semifluid contents via gas pressure. The invention can also be denoted with the symbol B67C9/00, which includes the emptying of bottles and is not included elsewhere, and it can be denoted by symbol B67D5/00, which is related to devices and systems for dispensing fluids.

### TECHNICAL PROBLEM

The technical problem which is solved by using the present invention involves the construction of a dispensing system for bottled beverages, wherein the sub-assembly containing the bottle is detachable from other system sub-assemblies, and the beverage which remains inside the bottle is kept in the protective atmosphere of an inert gas. All of this is achieved by applying electromagnetic valves and corresponding pipes which will introduce the inert gas into the bottle, as well as a pipe for dispensing the beverage into a glass.

The device is made in a way that enables one to dispense a precisely predetermined volume of beverage, which is proportional to the amount of time during which the corresponding electromagnetic valves are open, by applying a programmable button switch with a single push.

Additionally, it is possible to dispense any desired amount of beverage, as long as the corresponding valves are open, using a non-programmable button switch, which is pushed manually under pressure and is kept active for any given duration of time.

### BACKGROUND

It is known that dispensing beverages from bottles is performed on a daily basis, more often than not manually, without an accurate amount the beverage being dispensed into the glass.

A review of patent documentation has revealed a certain number of documents which are related to dispensing the contents of a bottle, but all of the designs are quite different compared to the solution which is presented by this invention.

Domestic patent no. 34380 describes the solution for a liquid dispenser cork, which is intended to dispense liquids from a bottle in specific precise doses, thus the application of this invention is of particular significance when using liquid medications which must be taken in specifically exact amounts.

Shown in domestic patent no. 39045 is the solution for a device used for the measuring of the dispensing of liquids, such as beverages, medications etc. During the dispensing and measuring of a specified amount of liquid, the device is positioned facing downward, wherein a vessel with a canal inside it, is placed in the container interior, and this canal is connected to a valve which is open towards the atmosphere.

An example of a cover with a liquid dispensing system for bottles is presented in patent no. 50649 B. It is positioned on the bottle and is activated via a handle, wherein a sliding valve, connected to a valve for releasing air into the bottle, is moved. By moving this sliding valve, the liquid is allowed to flow from the bottle, and the release valve allows the air from the atmosphere to enter the dispensed liquid.

In addition, domestic patent 49804 B shows the solution of a dispenser system for pressurised fluids, along with the process of maintaining the pressure of the fluid, its dispensing and a cartridge for generating pressure which is applied in this system and procedure. The device contains a vessel with a chamber used for receiving the fluid being dispensed, and a chamber for receiving the propellant, whereas the opening is located between the chambers during use. The propellant contains carbon-dioxide, whereas the fillers contain an active gas. This device enables the dispensing of completely fluid contents under the appropriate pressure.

There is a known solution for a device and method of dispensing and conserving bottled liquids, such as wine, which is described by the patent U.S. Pat. No. 4,595,121, which at a first glance appears to be similar to the solution given by this application, however it does not solve the problem which is solved by this application.

There is a recognised solution for a device and the method of dispensing and conserving bottled liquids, such as wine, which is described by the patent U.S. Pat. No. 4,595,121, wherein an inert gas is released into a bottle through an assembly which is made of a valve and a pipe—thus the beverage under the inert gas pressure goes through a pipe and another valve, and is brought to another pipe and flows into the glass through an opening via the valve.

In patent no. U.S. Pat. No. 4,706,847, the solution for a wine dispenser is provided, whereby an inert gas is released into the bottle and wine is dispensed into a glass through an assembly made of a cork built into the bottle neck. A pipe for supplying the inert gas to the bottle passes through the cork, along with the pipe for dispensing the wine.

Neither of the above-mentioned solutions solves the technical problem which is described and solved in this patent application which being submitted, although at first glance, there may be similarities, in particular with patent U.S. Pat. No. 4,595,121.

### DETAILED DESCRIPTION OF THE INVENTION'S ESSENTIALS

The Detachable Precious Liquids Dispenser System consists of a tank containing an inert gas, pipes for transporting the inert gas and the precious liquid from the bottle, electromagnetic valves, an irreversible valve and a button switch, which are arranged in three sub-assemblies.

One sub-assembly consists of the tank which contains the inert gas, pipes, electromagnetic valves, two button switches with their corresponding electric lines and part of the pipeline.

The second sub-assembly contains the remaining part of the pipeline from the first sub-assembly, a tube and the electromagnetic thread of the electromagnetic valve.

The third sub-assembly, which represents the cork, is made up of an irreversible valve, three tubes and an electromagnetic valve, which is positioned at the bottleneck, thus it forms a separate unit to the bottle, which can be presented separately from the other two sub-assemblies.

The subsystem for dosing the inert gas is programmed in advance so that the electromagnetic valves and the irreversible valve are open for a desired duration, based on how the programmable button switch has been programmed (e.g. 1, 2, 3, . . . seconds). Thus during this time an amount of inert gas, which is proportional to the programmed time, is released into the bottle.

By using a programmable button switch, the electromagnetic threads of the valves are put under voltage via electric lines, thus the electromagnetic valves open and remain open for the programmed duration, allowing the pressurised inert gas to enter the bottle through the pipes and valves and to push the precious liquid towards the glass.

The irreversible valve is opened under pressure (which is higher than atmospheric pressure), by the inert gas that arrives from the tank; hence the inert gas enters the bottle (achieving an overpressure in the bottle) for as long as the irreversible valve is open. Once the programmed duration of the open electromagnetic valves is over, an amount of precious liquid proportional to the amount of inert gas released into the bottle, flows out, hence the pressure inside the bottle becomes equal to the atmosphere pressure and the remaining liquid stays in the protective atmosphere of the inert gas, once the electromagnetic valves are closed.

By using the button switch, which is not programmable, the process takes place in the same way as when using the programmable button switch, but lasts only for as long as the button switch is kept on. In this way, it is possible to empty the entire contents of the bottle with a single activation of the button switch, keeping it under pressure for the amount of time which is sufficient for the entire amount of precious liquid to flow out of the bottle.

The advantages of this invention include: the ability of being able to present the cork and bottle separately from the rest of the system; the ability to program the subsystem for the dosing of the inert gas in advance, so that the releasing of the inert gas into the bottle can be performed in accordance with the programming of the programmable button switch. In addition, dosing of the inert gas using the non-programmable button switch can be performed while this switch is activated.

In any case, the amount of inert gas released from the tank, the amount of precious liquid dispensed out of the bottle, the bottle pressure and the time during which the valves are open are proportional, and the amount of liquid remaining in the bottle is in the protective atmosphere of the inert gas.

### BRIEF DESCRIPTION OF THE DRAWINGS

This invention is described in detail in the examples provided by the drawings, wherein:

FIG. 1—represents a schematic view of the Detachable Precious Liquids Dispenser System, especially useful for wines, with detached sub-assemblies.

FIG. 2—represents the schematic view of the Detachable Precious Liquids Dispenser System, especially useful for wines, in its assembled (working) position.

FIG. 3—represents a partial cross-section of the sub-assembly consisting of an electromagnetic valve thread and tube and the pipeline for supplying the inert gas to the bottle.

FIG. 4—represents a partial cross-section of the sub-assembly consisting of the cork and bottle.

FIG. 5—represents a partial cross-section of the sub-assemblies from FIGS. 3 and 4 combined.

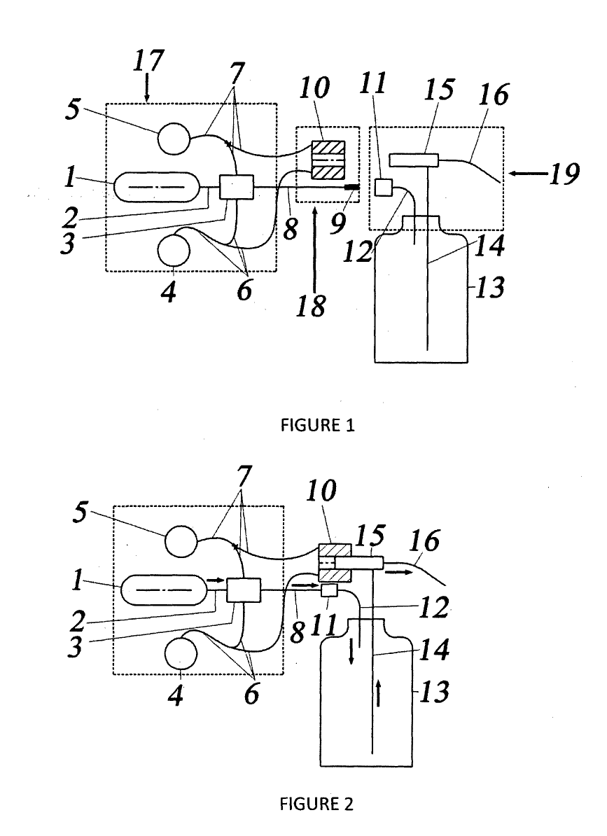

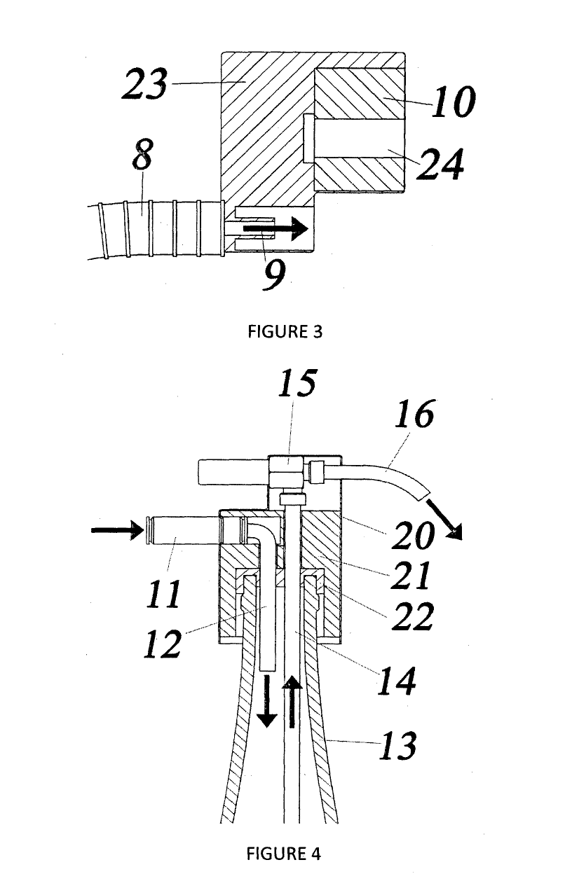

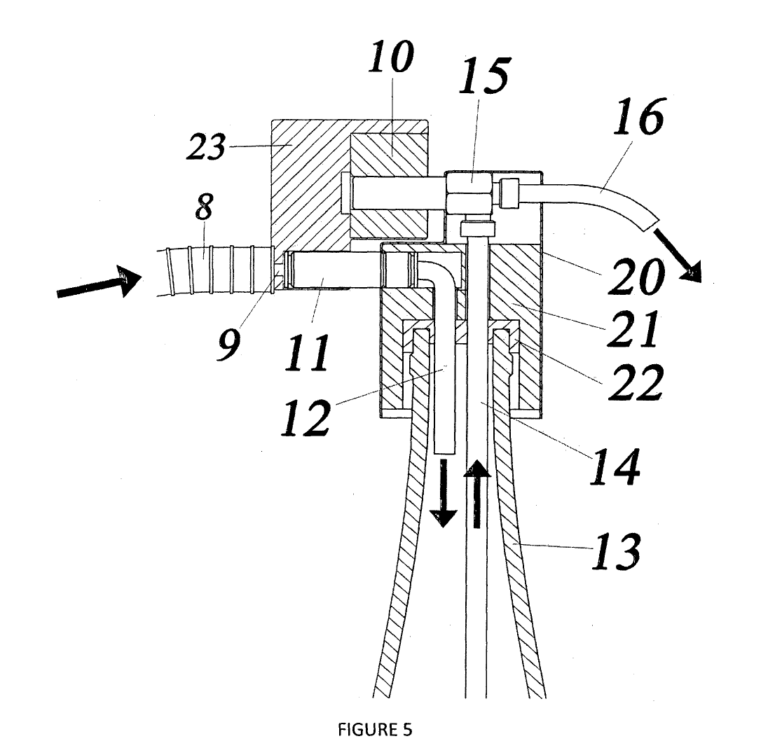

### DETAILED DESCRIPTION OF THE INVENTION

Shown in the figures is the Detachable Precious Liquids Dispenser System, especially useful for wines, which consists of sub-assemblies 17 and 18, cork 19 and bottle 13.

Sub-assembly 17 consists of a tank 1 for the containment of the inert gas, pipeline 2, electromagnetic valve 3, programmable button switch 4, with its accompanying electric lines 6, button switch 5 with its accompanying electric lines 7 and a part of the tube line 8.

Sub-assembly 18 contains the housing 23, part of the tube line 8, pipeline 9 and electromagnetic thread 10, of the electromagnetic valve 15.

The cork 19, consists of an irreversible valve 11, tube 12, tube 14, electromagnetic valve 15, tube 15, seal 22, housing 21 and support 20.

Electromagnetic valve 3 is connected on one side to tank 1 via the pipeline 2, whereas on the other side, it is connected to the tube line 8 via pipeline 9. The other end of pipeline 9 is connected to the irreversible valve 11 entrance, whereas tube 12 is connected to the irreversible valve 11 exit.

Tube 12 passes through housing 21, and rubber seal 22, and its other end is introduced into the upper part of the bottle 13. Pipeline 9 was made together with the housing 23, wherein housing 23 also contains the electromagnetic thread 10.

Programmable button switch 4 is connected, via one branch of the electric line 6, to the electromagnetic thread (not shown individually in the drawings) of the electromagnetic valve 3, whereas the second branch of pipeline 6 connects it to the electromagnetic thread 10, of the electromagnetic valve 15.

Button switch 5 (non-programmable) is connected in the same way, via one branch of electric line 7, to the electromagnetic thread of the electromagnetic valve 3, whereas the other branch of electric line 7 connects it to the electromagnetic thread 10, of electromagnetic valve 15.

Electromagnetic valve 15 is connected to the tube 14 via one end of tube 14 which is introduced into the electromagnetic valve 15, whereas the other end of tube 14 is introduced into the bottle 13, and tube 14 passes through housing 21 and seal 22 and it reaches the bottom of the bottle 13. Electromagnetic valve 15 is connected to tube 16 by means of introducing one end of tube 16 into electromagnetic valve 15, whereas the other end of tube 16 is free and is connected to the atmosphere.

Electromagnetic valve 15 is detachable from electromagnetic thread 10 and belongs to the cork 19. Thus, the cork 19, located at the neck of bottle 13, along with bottle 13, represents a separate entity, which can be presented individually from the sub-assemblies 17 and 18 and deposited at any given location (on a counter, in the refrigerator or anywhere else), wherein the electromagnetic valve 15 is disconnected from the electric grid.

In this way, only one assembly is used, consisting of sub-assemblies 17 and 18, to which bottles containing various precious liquids are attached as is required, since one bottle 13 (containing, for example, red wine) with cork 19 can be simply detached from the assembly made of sub-assemblies 17 and 18, and another bottle 13 (e.g. containing white wine or any other beverage) with its cork 19 can be attached. In this way, it is necessary to have a greater number of corks 19, which remain in their bottles 13, until the contents of the bottle 13 have been emptied, and the bottle does not need to be connected to sub-assemblies 17 and 18 at all times.

During the dispensing of the beverage, sub-assemblies 17 and 18 with cork 19 and bottle 13 represent a single entity, and during this time electromagnetic valve 15 is placed in opening 24.

Rubber seal 22 is placed inside a cylindrical opening (which is not marked with a number in the figures provided) of housing 21 and on top of bottleneck 13, hence it covers the top of the bottleneck from the outer side and partially enters it. Between the rubber seal 22 and bottleneck 13, both on the inner and outer sides, a rigid connection is achieved, as well as between the opening of rubber seal 22 and tube 12, and the opening on rubber seal 22 and tube 14. In this way, the contents of bottle 13 are sealed and isolated from the outside atmosphere. The joint between the cylindrical opening on housing 21, through which tube 12 passes, along with the joint between the cylindrical opening on housing 21 through which tube 14 passes, is very loose. Located inside the cylindrical opening on housing 21 is irreversible valve 11.

Housing 21 with a rubber seal 22, irreversible valve 11, tubes 12 and 14, electromagnetic valve 15 and tube 16 are placed inside a support 20, in this way forming cork 19, wherein the irreversible valve 11, electromagnetic valve 15 and tube 16 are partially outside of the support 20.

The sub-system for the dosing of inert gas consists of an electromagnetic valve 3, programmable button switch 4, with its accompanying electric lines 6, button switch 5 with its accompanying electric lines 7, and electromagnetic thread 10. The sub-system is pre-programmed so that the electromagnetic valve 3 is open for the desired duration, according to how programmable button switch 4 is programmed (e.g. 1, 2, 3, . . . seconds), thus during this time an amount of inert gas proportional to the programmed duration, i.e. the period during which electromagnetic valve 3 is open, is released from tank 1 into bottle 13.

By pressing the programmable button switch 4, the electromagnetic thread (not shown in the drawings) of the electromagnetic valve 3 is put under voltage via one branch of electric line 6, whereas the electromagnetic thread 10 of electromagnetic valve 15 is put under voltage via the second branch of electric line 6, and as a result, electromagnetic valves 3 and 15 open. Electromagnetic valves 3 and 15 remain open for the programmed duration, and the inert gas under pressure from tank 1 enters bottle 13 through pipeline 2, electromagnetic valve 3, tube 8, tube 9, irreversible valve 11 and tube 12, thus forcing the beverage through tube 14 and electromagnetic valve 15 into tube 16 through which the glass is filled (not shown in the drawings). Irreversible valve 11 is opened under pressure (which is higher than atmospheric pressure) from the inert gas which arrives from tank 1, hence the inert gas enters bottle 13 (and achieves overpressure in bottle 13) for as long as the irreversible valve 11 is open. Once the programmed time duration during which electromagnetic valves 3 and 15 are open expires, and the amount of beverage proportional to the amount of inert gas released into bottle 13, the pressure in the bottle 13 becomes equal to the atmospheric pressure and the beverage remaining in the bottle 13 stays in the protective inert gas atmosphere once electromagnetic valves 3 and 15 are closed.

By pressing the programmable button switch 5, the electromagnetic thread (not shown in the drawings) of the electromagnetic valve 3 is put under voltage via one branch of electric line 7, whereas the electromagnetic thread 10 of the electromagnetic valve 15 is put under voltage via the second branch of electric line 7, and as a result, electromagnetic valves 3 and 15 open and remain so for as long as button switch 5 is active (being pressed). For the programmed duration, electromagnetic valves 3 and 15 remain open, and the inert gas under pressure from tank 1 enters bottle 13 through pipeline 2, electromagnetic valve 3, tube 8, tube 9, irreversible valve 11 and tube 12, thus forcing the beverage through tube 14 and electromagnetic valve 15 into tube 16 through which the glass is filled. When using the device in this way, irreversible valve 11 is also opened under inert gas pressure (which is higher than atmospheric pressure), which arrives from tank 1, thus the inert gas enters bottle 13 (achieving overpressure in bottle 13) for as long as the irreversible valve 11 is open. While electromagnetic valves 3 and 15 are open, an amount of beverage which is proportional to the amount of inert gas released into bottle 13 flows out, and once button switch 5 is released, and the pressure in bottle 13 becomes equal to the atmospheric pressure, the flow of beverage into the glass stops and the remaining beverage stays in bottle 13, in a protective inert gas atmosphere, once electromagnetic valves 3 and 15 are closed.

In this way it is possible to empty the entire contents of bottle 13 with the single activation of button switch 5, by keeping it pressed long enough, until all of the beverage flows out of bottle 13. By releasing button switch 5, the electromagnetic thread of electromagnetic valve 3, as well as the electromagnetic thread 10 of electromagnetic valve 15 are no longer under voltage, hence electromagnetic valves 3 and 15 are closed, and in this way the flow of inert gas into bottle 13 and the flow of beverage through tube 16 are interrupted.

This device has been made in such a way that ensures the complete sealing of all joints and which prevents any leakage of the inert gas and beverage.

In a device which is constructed in this way, the inert gas is always present above the beverage content in the bottle 13. When the bottle 13, together with cork 19, is connected with the sub-assemblies 18 and 17, the inert gas is present in bottle 13 above the beverage, regardless of whether electromagnetic valves 3 and 15 are open or closed.

In the situation that the bottle 13 with cork 19 is separated from sub-assemblies 18 and 17, electromagnetic valves 3 and 15 are closed, hence the inert gas is also above the beverage content in the bottle 13, since the irreversible valve 11 is closed as well.

In this way, by using the irreversible valve 11, the inert gas which is released into the bottle 13 constantly remains above the beverage content in the bottle 13.

In any situation when the electromagnetic valves 3 and 15 are closed, there is isolated atmospheric pressure in bottle 13, since, due to the inert gas pressure, a proportional amount of precious liquid is dispensed from the bottle 13, and as a result, the pressure in bottle 13 decreases and is equal to the atmospheric pressure.

The precious liquid comes into contact with the atmosphere only once it is in the glass, and in this way, the properties of the precious liquid that remain in the bottle 13, are preserved.

This invention's innovativeness is represented by the potential of being able to detach the bottle 13, and the cork 19, as a whole from the sub-assemblies 18 and 17 whenever required, while ensuring that the inert gas released into the bottle 13, above the precious liquid, cannot leave the bottle 13, which is achieved by installing an irreversible valve 11.

At the same time, it is possible to precisely measure the amount of inert gas released into the bottle 13 through tube 12, and in this way, an amount of precious liquid, proportional to the amount of inert gas released, is dispensed into the glass, and all of this is achieved by means of electromagnetic valve 3 and electromagnetic valve 15 with electromagnetic thread 10 and programmable button switch 4, wherein the timespan during which the electromagnetic valves 3 and 15 are open is programmed.

It is possible to release varying amounts of inert gas into the bottle 13 through tube 12, hence an amount of precious liquid proportional to the amount of inert gas is dispensed into a glass, all of which is achieved by means of electromagnetic valve 3 and electromagnetic valve 15 with electromagnetic thread 10 and programmable button switch 5, wherein the timespan during which electromagnetic valves 3 and 15 are open is not programmed.

In any case, the amount of inert gas released from tank 1, the amount of precious liquid dispensed from the bottle 13, the pressure in bottle 13 and the duration during which electromagnetic valves 3 and 15 and the irreversible valve 11 are open are proportional.

A device constructed in this way, according to the invention, achieves an original solution which was the inventor's intention.

Review of numbering of positions, as used in the figures and text:
01) Tank 1
02) Pipeline 2
03) Electromagnetic valve 3
04) Programmable button switch 4
05) Button switch 5
06) Electric line 6
07) Electric line 7
08) Tube line 8
09) Pipeline 9
10) Electromagnetic thread 10
11) Irreversible valve 11
12) Tube 12
13) Bottle 13
14) Tube 14
15) Electromagnetic valve 15
16) Tube 16
17) Sub-assembly 17
18) Sub-assembly 18
19) Cork 19
20) Support 20
21) Housing 21 for cork 19
22) Rubber seal 22
23) Housing 23 of electromagnetic thread 10
24) Opening 24

1. An apparatus for dispensing liquid from a bottle comprising an electromagnetic valve (3) connected, on one side, with the tank (1) via a pipeline (2), and one end of a tube (12), which is introduced into the upper part of the bottle (13), and one end of a tube (14) is introduced into the bottle (13) and reaches the vicinity of the bottom of the bottle (13), thus the liquid is dispensed into a glass through the tube (14) and the a tube (16); a cork (19), comprising an irreversible valve (11), the tube (12), and the tube (14), an electromagnetic valve (15), the tube (16), a seal (22), a housing (21) and support (20), located at a bottleneck of the bottle (13), together with the bottle (13) represents a separate entity, which can be presented separately from sub-assemblies (18) and (17), and the electromagnetic valve (15) is disconnected from the electric grid; and the electromagnetic valve (3) is connected on its other side with a pipeline (9) via a tube (8); the pipeline (9) is connected by its other end to the irreversible valve (11) entrance, wherein the irreversible valve (11) exit is connected to the tube (12); and an electromagnetic thread (10) is located inside housing (23).

2. The apparatus of claim 1, wherein the seal (22) is placed inside a cylindrical opening in the housing (21) and on top of the bottleneck of the bottle (13) in such a way that it covers the top of the bottleneck from the outside and partially enters the bottleneck.

3. The apparatus of claims 1, further comprising a rigid connection between the seal (22) and the bottleneck of bottle (13), located on both inner and outer sides of said bottle (13), as well as between the opening on the seal (22) and tube (12) and the opening on the seal (22) and tube (14).

4. The apparatus of claim 2 further comprising a loose joint between the cylindrical opening in the housing (21), through which tube (12) passes, as well as a loose joint between the cylindrical opening in the housing (21), through which the tube (14) passes.

5. The apparatus of claim 1 wherein the irreversible valve (11) is located inside the lateral cylindrical opening in the housing (21).

6. The apparatus of claim 1 wherein the housing (21), the seal (22), the irreversible valve (11), the tubes (12), the tube (14), the electromagnetic valve (15) and the tube (16), are placed inside support (20).

7. The apparatus of claim 1 wherein the tube (12) passes through the housing (21) and the seal (22) and the tube (14) pass through the housing (21) and the seal (22).

8. The apparatus of claim 1, wherein the pipeline (9) and the housing (23) comprises a single element.

9. The apparatus of claim 1 further comprising a programmable button switch (4) connected to the electromagnetic thread of the electromagnetic valve (3) via one branch of the electric line (6), whereas the second branch of the electric line (6) connects the button switch with an electromagnetic thread (10) of the electromagnetic valve (15).

10. The apparatus of claim 1 further comprising a button switch (5) connected to the electromagnetic thread of the electromagnetic valve (3) via one branch of the electric line (7), whereas the second branch of the electric line (7) connects the button switch to an electromagnetic thread (10) of the electromagnetic valve (15).
